(19) United States
(12) Patent Application Publication
(10) Pub. No.: US 2010/0319803 A1
(43) Pub. Date: Dec. 23, 2010

(54) FUELING SYSTEM AND METHOD THEREFOR

(76) Inventors: Max Mowzoon, Paradise Valley, AZ (US); Ehsan Mowzoon, Paradise Valley, AZ (US)

Correspondence Address: WEISS & MOY PC, 4204 NORTH BROWN AVENUE, SCOTTSDALE, AZ, 85251, US

(21) Appl. No.: 12/488,198

(22) Filed: Jun. 19, 2009

(51) Int. Cl. B67D 5/04; B67D 5/08

(52) U.S. Cl. 141/1; 141/284; 141/94

(57) ABSTRACT

An improved fueling system is disclosed. Each vehicle is equipped with its own operation means to control the distribution from a fuel pump to the vehicle. This will prevent people from having to touch the same fuel pumps. Each vehicle will have a memory device that will store information such as the type of fuel last used to fill the fuel tank of the vehicle, financial information of the vehicle's owner, and the minimum standard of fuel required by the vehicle. Once the fuel pump receives this data from the vehicle's memory device, then user may then initiate fuel transfer. This system may also prevent a car from refueling the stolen car if the fuel pump recognizes the vehicle's data (e.g. VIN number) as having been reported stolen.

### FIELD OF THE INVENTION

This invention relates generally to filling stations and, more particularly, to an improved fueling system and related method.

### BACKGROUND OF THE INVENTION

When a person's vehicle runs low on gas, the person usually goes to a filling station to refill the vehicle's fuel tank. A typical filling station will have several fuel pumps that distribute several types of fuel: regular unleaded, super unleaded, propane, and diesel being among them. Some people, however, are not aware of the type of fuel that their vehicle requires and often refill their tanks with the wrong type. This could lead to engine damage.

There are also many people that touch the same pump handles on any given day. This may lead to the spread of bacteria, illness, and disease. Some people may bring hand sanitizer or hand wipes to clean their hands, but having to carry these items on a regular basis may prove to be inconvenient.

Another problem with the refueling pumps used today is that fuel left over from the previous user remains in the hose. When the person is finished refueling, much fuel drips to the floor and is wasted when the hose is transferred back to the pump. Still another problem that arises from the left over fuel in the hose is fuel mixing. If the previous user only used regular unleaded fuel, the current user may be receiving up to about 0.5 gallon of regular unleaded fuel even though he may be paying for super unleaded fuel. The user is therefore paying a higher price for about 0.5 gallon of the lower grade of fuel.

The present invention is directed to a fueling system that will provide for a more sanitary way for people to refuel their vehicles. The fueling system may also provide a way to assist vehicle owners in selecting the proper fuel for their vehicles.

### SUMMARY OF THE INVENTION

In accordance with one embodiment of the present invention, an improved fueling system is disclosed. The fueling system comprises a fuel pump for dispensing at least one type of fuel, and operation means for controlling the distribution of fuel to a vehicle, wherein the operation means is coupled to the vehicle.

In accordance with another embodiment of the present invention, an improved fueling system is disclosed. The fueling system comprises a fuel pump for dispensing at least one type of fuel, an operating handle for controlling the dispensing of fuel to a vehicle, and a hose for delivering fuel from the fuel pump to the vehicle, wherein the hose has a first end coupled to a fuel tank of the vehicle and a second end coupled to the operating handle.

In accordance with another embodiment of the present invention, an improved fueling system is disclosed. The fueling system comprises a fuel pump having one fuel port for dispensing at least one type of fuel, wherein the fuel port removably couples directly to a fuel tank of a vehicle, an operating terminal for controlling the distribution of fuel to the vehicle, wherein the operating terminal is coupled to an interior of the vehicle, a vehicle parking area, an actuator that moves the fuel port vertically between a retracted stored position and an extended dispensing position, and a sensor, wherein the actuator moves the fuel port into the extended dispensing position when the sensor senses the presence of the vehicle in the parking area, and wherein the actuator returns the fuel port into the retracted stored position when the sensor senses a departure of the vehicle from the parking area.

In accordance with still another embodiment of the present invention, a method for refueling is disclosed. The method comprises the steps of providing a fueling system comprising a fuel pump for dispensing at least one type of fuel; operation means for controlling the distribution of fuel to the vehicle, wherein the operation means is coupled to the vehicle; and connection means for delivering fuel from the fuel pump to a fuel tank of the vehicle; transmitting data from the vehicle to the fuel pump through a data connection, the data being specific to the vehicle; and dispensing fuel from the fuel pump to the fuel tank according to the data transmitted from the vehicle to the fuel pump.

The foregoing and other objects, features, and advantages of the invention will be apparent from the following, more particular description of the preferred embodiments of the invention, as illustrated in the accompanying drawings.

### BRIEF DESCRIPTION OF THE DRAWINGS

The present invention will become more fully understood from the detailed description and the accompanying drawings, wherein:

FIG. 1 is a perspective view of a fueling system in accordance with the present invention.

FIG. 2 is a front view of a vehicle equipped with an operating handle and hose that may be used in the fueling system of FIG. 1.

FIG. 3 is a front view of a fuel pump that may be used in the fueling system of FIG. 1.

FIG. 4 is a perspective view of the operating handle and hose that may be used in the fueling system of FIG. 1.

FIG. 5 is an elevated perspective view of the fuel pump that may be used in the fueling system of FIG. 1.

FIG. 5a is another embodiment of the operating handle, hose, and fuel pump of the fueling system of the present invention.

FIG. 6 is a perspective view of another embodiment of the fueling system of the present invention.

FIG. 7 is a side view of the fueling system of FIG. 6 shown in use.

FIG. 8 is a side view of a fuel port of the fueling system of FIG. 6, shown coupled to a vehicle's fuel tank.

FIG. 9 is a perspective view of an operating terminal of the present invention.

### DETAILED DESCRIPTION OF THE PREFERRED EMBODIMENTS

The novel features believed characteristic of the invention are set forth in the appended claims. The invention will best be understood by reference to the following detailed description of illustrated embodiments when read in conjunction with the accompanying drawings, wherein like reference numerals and symbols represent like elements.

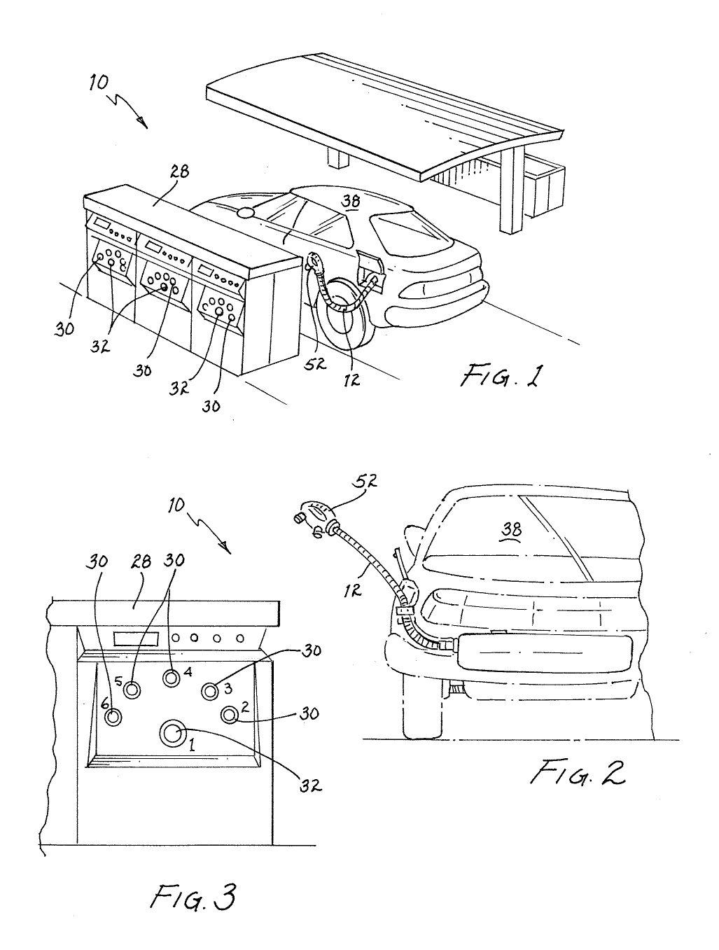

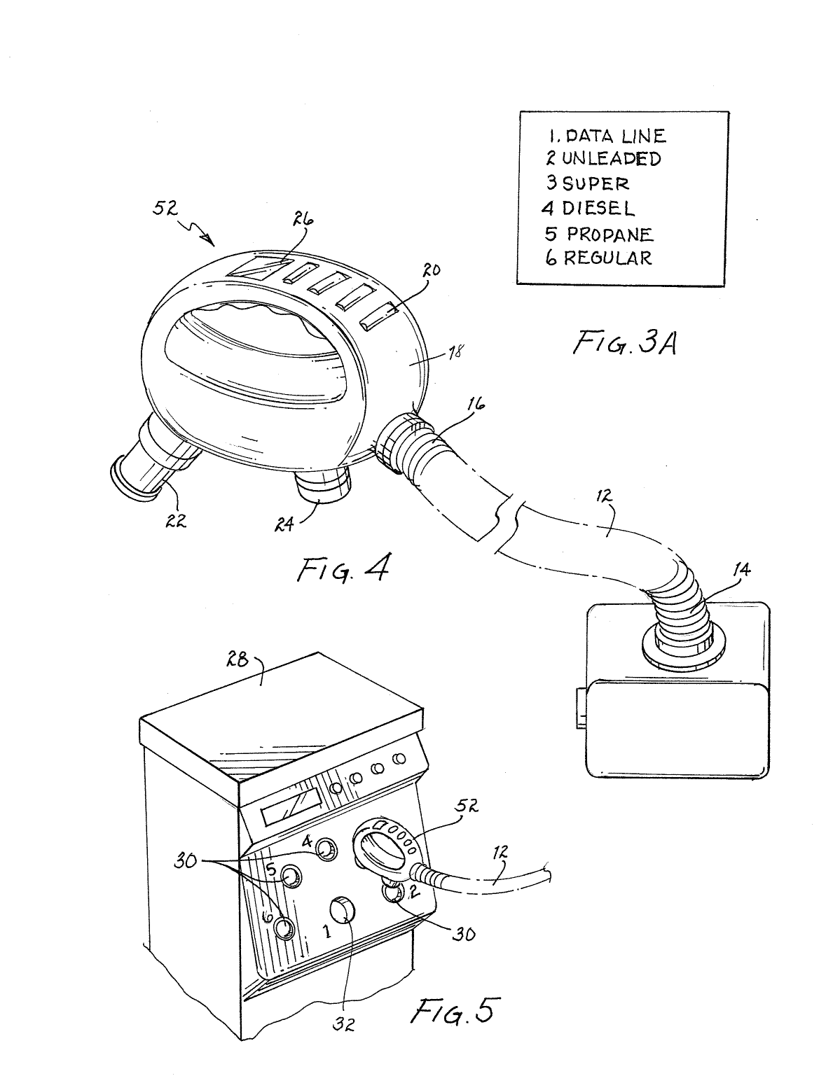

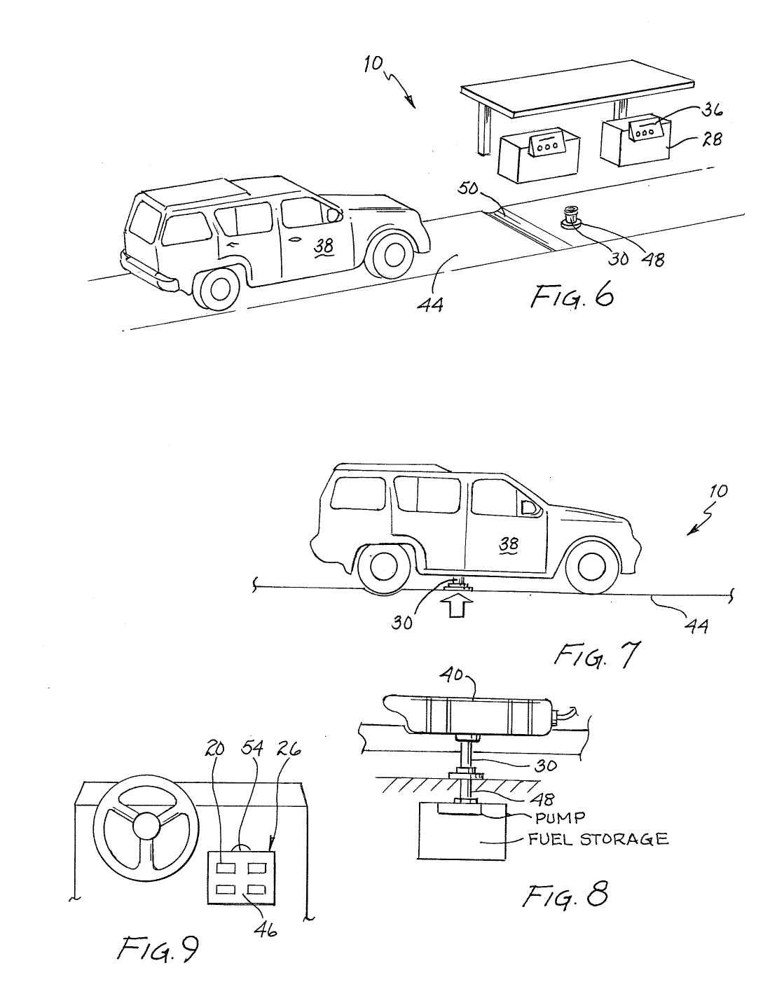

Referring to FIGS. 1-9, an improved fueling system, fueling system 10, is disclosed. The fueling system 10 comprises a fuel pump 28 and operation means for controlling the distribution of fuel to a vehicle 38.

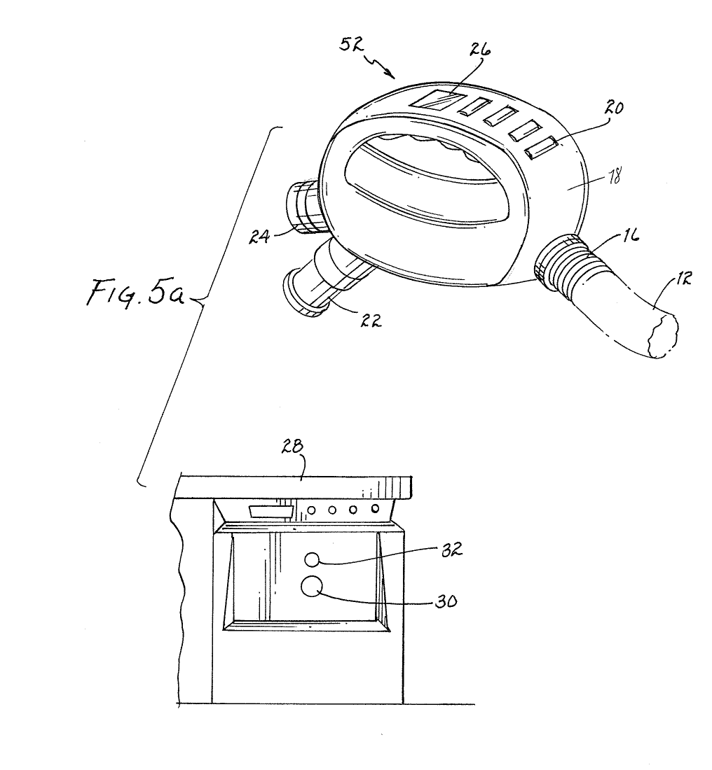

FIGS. 1-5b shows one embodiment of the present invention. The fuel pump 28 may dispense several types of fuel; e.g. regular unleaded, super unleaded, diesel, propane. It should be clearly understood that the fuel may be any kind of fuel or energy source (e.g. electrical energy), now used or developed in the future, that is capable of being transferred from the fuel pump 28 to the vehicle 38 in the manner herein disclosed. It should also be clearly understood that the vehicle 38 may be any type of vehicle 38 including a car, a truck, a motorcycle, etc. now in use or developed in the future. The fuel pump 28 has at least one fuel port 30 for dispensing fuel. FIGS. 1, 3, and 5 show a fuel pump 28 that has one fuel port 30 for each type of fuel, whereas FIG. 5b shows a fuel pump 28 that has only one fuel port 30 for dispensing all of the available types of fuel. It should be clearly understood that substantial benefit may be derived from any number of fuel ports 30. The fuel pump 28 may also have a data port 32 for receiving data from the vehicle 38.

In this embodiment the operation means is an operating handle 52. The operating handle 52 has a handle portion 18 for the user to grip and has a fuel port connection end 22 for connecting to a fuel port 30 of the fuel pump 28. The fuel port connection end 22 of the operating handle 52 may be a male connector and the fuel port 30 of the fuel pump 28 may be a female connector, which together form a seal that will help to prevent fuel leakage. The operating handle 52 may also have a data port connection end 24 for connecting to the data port 32 of the fuel pump 28. The data port connection end 24 of the operating handle 52 may be a male data connector and the data port 32 of the fuel pump 28 may be a female data connector, which together form a data connection. Any suitable data communication cables/connections may be used, even wireless data connections. For example, fiber optic cables in the data port connection end 24 may be formed integrally with the fuel port connection end 22 with data cables running the length of the hose 12. It should be clearly understood that the scope of the invention should not be limited to the examples herein described.

The operating handle 52 may also have command keys 20. Command keys 20, when activated, may be used to for starting fuel dispensing, ending fuel dispensing, selecting the type of fuel, and/or conducting a financial transaction so that the owner of the vehicle 38 may pay for the fuel.

The operating handle 52 may also have a programmable memory device 26 that stores data particular to the vehicle 38. For example, the memory device 26 may store data such as the type of fuel that was last used to fill the fuel tank 40 of the vehicle 38, financial information of the owner of the vehicle 38 (credit card numbers, personal identification, etc. that may be programmed into the memory device by the vehicle 38 owner), a VIN number of the vehicle 38, and the minimum grade of fuel required by the vehicle 38 (giving the owner the opportunity to upgrade if he/she wishes).

Storing data that is particular to the vehicle 38 would be helpful in making sure that the proper type of fuel is used and may also be helpful in processing a financial transaction for payment of the fuel. Furthermore, if the vehicle 38 is stolen, the fueling systems 10 may be notified by the legal authorities that a vehicle 38 with a certain VIN number has been stolen. When the fuel pump 28 receives the VIN number data of the vehicle 38 through the data port 32, the fuel pump 28 may refuse to dispense fuel to that vehicle 38 if it has the VIN number of the vehicle 38 that has been reported stolen.

The operating handle 52 may be powered by battery housed within the operating handle 52, or it may be wire-connected to the vehicle's 38 engine computer and powered by the vehicle's 38 battery.

A hose 12 may be used for delivering fuel from the fuel pump 28 to the vehicle 38. The hose 12 may have a first end 14 coupled to the vehicle's 38 fuel tank 40 and may have a second end 16 coupled to the operating handle 52. The length of the hose 12 may be extendable and retractable and stored proximate the vehicle's 38 body so that it will not drag.

As shown in FIGS. 1, 3, and 5, the distance between each of the fuel ports 30 and the data port 32 may be substantially equidistant so that the fuel port connection end 22 and the data port connection end 24 of the operating handle 52 may be connected to both the fuel port 30 and the data port 32, respectively, at the same time regardless of which type of fuel is selected. Or, as shown in FIG. 5b, the fuel port connection end 22 may be coupled proximate the data port connection end 24 so that they may be connected to the fuel port 30 and the data port 32, respectively, at the same time.

Referring now to FIGS. 6-9, another embodiment of the fueling system 10 is disclosed. In this embodiment, there is a vehicle parking area 44 where a driver will park the vehicle 38 and turn off the engine. There may be wall/floor markings or floor indentations for the vehicle's 38 wheels to rest in so that the owner will know exactly where to park the vehicle 38.

The fuel pump 28 may have one fuel port 30 located in the floor of the vehicle parking area 44 that moves vertically between a retracted stored position and an extended dispensing position. A sensor 50 may be positioned proximate the vehicle parking area 44. An actuator 48 may be coupled to the fuel port 30 so that when the sensor 50 senses the presence of the vehicle 38 in the vehicle parking area 44, the actuator 48 will move the fuel port 30 into the extended dispensing position. The sensor 50 may also be required to sense whether the engine of the vehicle 38 has been turned off before extending the fuel port 30. The fuel tank 40 of the vehicle 38 may have a fuel port connection end 22 that is a male connector and the fuel port 30 may be a female connector, which together would form a seal to prevent spillage of fuel. The engine may also be prevented from starting once the data/fuel connections is/are made.

Furthermore, when the sensor 50 senses that the vehicle has left the vehicle parking area 44, the actuator 48 will return the fuel port 30 to the retracted stored position.

In one embodiment, the operation means may be an interactive operating terminal 46 that is coupled to an interior of the vehicle 38. The operating terminal 46 may be coupled on the dashboard proximate a driver's seat so that the driver may easily control the dispensing of fuel. The operating terminal 46 may have a wireless transmitter 54 to transmit data to a wireless receiver 36 on the fuel pump 28. In another embodiment, a data port 32 may be integrally formed with the fuel port 30. For example, the fuel tank 40 may have a fuel port connection end 22 that is a male connector and the fuel port 30 may be a female connector fiber optic cables may be used in the fuel port 30 to establish the data connection when the fuel port connects to the fuel tank 40 of the vehicle 38, which together would form a seal to prevent spillage of fuel.

The operating terminal 46 may have command keys 20 to control the start of fuel dispensing, the end of fuel dispensing, the selection of the type of fuel, and the conduction of a financial transaction so that the user may pay for the fuel. The operating terminal 46 may also have a memory device 26 for storing the data particular to the vehicle 38.

### Statement of Use

In one embodiment of the present invention, the fueling system 10 may comprise a fuel pump 28 for dispensing at least one type of fuel, wherein the fuel pump 28 has at least one fuel port 30 and a data port 32, an operating handle 52 for controlling the distribution of fuel to the vehicle 38, wherein the operating handle 52 comprises: a handle portion 18 for a user to grip; a fuel port connection end 22 for coupling to the fuel port 30 of the fuel pump 28; a data port connection end 24 for coupling to the data port 32 of the fuel pump 28; and a memory device 26 for storing data particular to the vehicle 38, and a hose 12 for delivering fuel from the fuel pump to the vehicle, wherein the hose 12 has a first end 14 coupled to a fuel tank 40 of the vehicle 38 and a second end 16 coupled to the operating handle 52.

A vehicle 38 owner may connect the fuel port connection end 22 of the operating handle 52 to a fuel port 30 of the fuel pump 28 and may connect the data port connection end 24 of the operating handle 52 to the data port 32 of the fuel pump 28. Once the data connection is established, data from the memory device 26 may be transmitted to the fuel pump 32. It should be clearly understood that the data connection may be wireless. For example, the fuel pump 32 may receive data indicating that the vehicle 38 was last filled with super unleaded fuel and the minimum grade of fuel required by the vehicle 38 is regular unleaded fuel. The fuel pump 32 may also receive the information for a credit card that the owner will be using to pay for the fuel as well as personal identification of the owner. Furthermore, the fuel pump 32 may receive information on the vehicle itself, like its VIN number and license plate number. If the fuel pump 28 recognizes the VIN number as belonging to a stolen vehicle 38, the fuel pump 28 may prevent the dispensing of fuel to the vehicle 38.

If the operating handle 52 has command keys 20, the owner may use the command keys 20 to choose to refill the fuel tank 40 with the minimum required regular unleaded fuel. Or the user may use the command keys 20 to choose to refill the fuel tank 40 with super unleaded like the last refill. Once the type of fuel has been selected, the user may then use the command keys 20 to start fuel dispensing. Fuel will then be dispensed from the fuel pump 28 to the fuel tank 40. The user may also use the command keys 20 to end fuel dispensing. Upon completion, the user may finally use the command keys 20 to initiate payment for the fuel with the financial information stored in the memory device 26.

The user may then disconnect the fuel port connection end 22 from the fuel port 30 and disconnect the data port connection end 24 from the data port 32, retract the hose 12, and leave the fueling station.

In another embodiment of the invention, the fueling system 10 may comprise: a fuel pump 28 having one fuel port 30 that removably couples directly to the fuel tank 40 of the vehicle 38; an operating terminal 46 located inside the vehicle 38 for controlling the distribution of fuel to the vehicle 38, which has a wireless transmitter 54 and a memory device 26 for storing data particular to the vehicle 38; a vehicle parking area 44; an actuator 48 that moves the fuel port 30 vertically between a retracted stored position and an extended dispensing position; and a sensor 50.

The vehicle 38 owner may park the vehicle 38 in the vehicle parking area 44. When the sensor 50 senses the presence of the vehicle 38 in the vehicle parking area 44, the actuator 48 may move the fuel port 30 into the extended dispensing position so that it may couple with the fuel tank 40 of the vehicle 38.

The data may then be sent from the wireless transmitter 54 of the operating terminal 46 to the wireless receiver 36 on the fuel pump 28. It should also be understood that the data connection may also be established with cables, wherein the cables are integral to the fuel port 30. The operating terminal 46 may also have command keys 20 to select fuel type, to start fuel dispensing, to stop fuel dispensing, and to complete the payment transaction. After payment has been completed, the driver may disconnect the fuel port connection end 22 of the fuel tank 40 from the fuel port 30 by driving the vehicle 38. When the sensor 50 senses that the vehicle 38 has left the vehicle parking area 44, the actuator 48 will move the fuel port 30 back into the retracted stored position.

While the invention has been particularly shown and described with reference to preferred embodiments thereof, it will be understood by those skilled in the art that the foregoing and other changes in form and details may be made therein without departing from the spirit and scope of the invention.

What is claimed is:

1. An improved fueling system comprising:
a fuel pump for dispensing at least one type of fuel; and
operation means for controlling the distribution of fuel to a vehicle, wherein the operation means is coupled to the vehicle.

2. The fueling system of claim 1 wherein the fuel pump comprises at least one fuel port.

3. The fueling system of claim 2 wherein the fuel pump comprises a plurality of fuel ports, each fuel port dispensing a different type of fuel.

4. The fueling system of claim 2 wherein the fuel pump comprises one fuel port for dispensing more than one type of fuel.

5. The fueling system of claim 1 wherein the operation means comprises at least one command key for controlling the fuel pump.

6. The fueling system of claim 5 wherein the operation means has a command key for at least one of starting fuel dispensing, ending fuel dispensing, selecting the type of fuel, and conducting a financial transaction.

7. The fueling system of claim 1 wherein the operation means further comprises a memory device for storing data particular to the vehicle.

8. The fueling system of claim 7 wherein the data comprises at least one of the type of fuel last used to fill a fuel tank of the vehicle, financial information of an owner of the vehicle, VIN number of the vehicle, and the fuel type required by the vehicle.

9. The fueling system of claim 1 further comprising a hose for delivering fuel from the fuel pump to the vehicle, wherein the hose has a first end coupled to a fuel tank of the vehicle and a second end coupled to the operation means.

10. The fueling system of claim 9 wherein the fuel pump further comprises a data port.

11. The fueling system of claim 10 wherein the operation means comprises:
a handle for a user to grip;
a fuel port connection end for coupling to the at least one fuel port of the fuel pump; and
a data port connection end for coupling to the data port of the fuel pump.

12. The fueling system of claim 4 further comprising:
a vehicle parking area;
an actuator that moves the fuel port vertically between a retracted stored position and an extended dispensing position; and
a sensor;
wherein the actuator moves the fuel port into the extended dispensing position when the sensor senses the presence of the vehicle in the parking area; and
wherein the actuator returns the fuel port into the retracted stored position when the sensor senses a departure of the vehicle from the parking area.

13. The fueling system of claim 12 wherein the operation means comprises an interactive terminal coupled to an interior of the vehicle proximate a driver's seat.

14. The fueling system of claim 12 wherein the fuel port couples to a fuel tank of the vehicle.

15. The fueling system of claim 12 wherein the fuel pump further comprises a wireless receiver to receive data from a wireless transmitter housed within the vehicle.

16. An improved fueling system comprising:
a fuel pump for dispensing at least one type of fuel;
an operating handle for controlling the dispensing of fuel to a vehicle; and
a hose for delivering fuel from the fuel pump to the vehicle, wherein the hose has a first end coupled to a fuel tank of the vehicle and a second end coupled to the operating handle.

17. The fueling system of claim 16 wherein the fuel pump comprises:
at least one fuel port; and
a data port.

18. The fueling system of claim 17 wherein the operating handle comprises:
a handle portion for a user to grip;
a fuel port connection end for coupling to the at least one fuel port of the fuel pump;
a data port connection end for coupling to the data port of the fuel pump;
at least one command key for at least one of starting fuel dispensing, ending fuel dispensing, selecting the type of fuel, and conducting a financial transaction; and
a memory device for storing data particular to the vehicle.

19. The fueling system of claim 18 wherein the data comprises at least one of the type of fuel last used to fill the fuel tank of the vehicle, financial information of an owner of the vehicle, VIN number of a vehicle, and the fuel type required by the vehicle.

20. An improved fueling system comprising:
a fuel pump having one fuel port for dispensing at least one type of fuel, wherein the fuel port removably couples directly to a fuel tank of a vehicle;
an operating terminal for controlling the distribution of fuel to the vehicle, wherein the operating terminal is coupled to an interior of the vehicle;
a vehicle parking area;
an actuator that moves the fuel port vertically between a retracted stored position and an extended dispensing position; and
a sensor;
wherein the actuator moves the fuel port into the extended dispensing position when the sensor senses the presence of the vehicle in the parking area; and
wherein the actuator returns the fuel port into the retracted stored position when the sensor senses a departure of the vehicle from the parking area.

21. The fueling system of claim 20 wherein the operating terminal comprises:
a wireless transmitter;
at least one command key for at least one of starting fuel dispensing, ending fuel dispensing, selecting the type of fuel, and conducting a financial transaction; and
a memory device for storing data particular to the vehicle.

22. The fueling system of claim 21 wherein the fuel pump further comprises a wireless receiver to receive data from the wireless transmitter, wherein the data comprises at least one of the type of fuel last used to fill a fuel tank of the vehicle, financial information of an owner of the vehicle, VIN number of the vehicle, and the fuel type required by the vehicle.

23. A method for refueling a vehicle comprising the steps of:
providing a fueling system comprising:
a fuel pump for dispensing at least one type of fuel;
operation means for controlling the distribution of fuel to the vehicle, wherein the operation means is coupled to the vehicle; and
connection means for delivering fuel from the fuel pump to a fuel tank of the vehicle;
transmitting data from the vehicle to the fuel pump through a data connection, the data being specific to the vehicle; and
dispensing fuel from the fuel pump to the fuel tank according to the data transmitted from the vehicle to the fuel pump.

24. The method of claim 23 wherein the fuel pump comprises:
at least one fuel port; and
a data port; and
wherein the operation means is an operating handle comprising:
a handle portion for a user to grip;
a fuel port connection end for coupling to the at least one fuel port of the fuel pump;
a data port connection end for coupling to the data port of the fuel pump;
at least one command key for at least one of starting fuel dispensing, ending fuel dispensing, selecting the type of fuel, and conducting a financial transaction; and
a memory device for storing the data particular to the vehicle; and
wherein the connection means is a hose comprising:
a first end coupled to the fuel tank of the vehicle; and
a second end coupled to the operating handle.

25. The method of claim 23 wherein the fuel pump comprises:
one fuel port, wherein the fuel port removably couples directly to the fuel tank of a vehicle; and
a wireless data receiver; and
wherein the operation means is an operating terminal coupled to an interior of the vehicle, wherein the operating terminal comprises:
a wireless data transmitter; and
a memory device for storing the data particular to the vehicle; and
wherein the fueling system further comprises:
a vehicle parking area;
an actuator that moves the fuel port vertically between a retracted stored position and an extended dispensing position; and
a sensor.

26. The method of claim 25 further comprising the steps of:
parking the vehicle in the vehicle parking area;
sensing the presence of the vehicle by the sensor; and
extending the fuel port upwardly into the dispensing position to couple to the fuel tank of the vehicle.

27. The method of claim 26 further comprising the steps of:
removing the vehicle from the vehicle parking area;
disengaging the fuel port from the fuel tank of the vehicle;
sensing the departure of the vehicle by the sensor; and
retracting the fuel port into the stored position.

28. The method of claim 23 wherein the data comprises at least one of the type of fuel last used to fill the fuel tank of the vehicle, financial information of an owner of the vehicle, VIN number of the vehicle, and the fuel type required by the vehicle.

29. The method of claim 23 further comprising the step of withholding the dispensing of fuel when the data has been identified as data for a stolen vehicle.
